(19) United States
(12) Patent Application Publication
(10) Pub. No.: US 2013/0185219 A1
(43) Pub. Date: Jul. 18, 2013

(54) SYSTEM TO ADMINISTER AN OUTCOME BASED EDUCATION

(71) Applicants: Mohd. Saleh Jaafar, Selangor (MY); Megat Johari Megat Megat Mohd Noor, Selangor (MY); Nor Kamariah Noordin, Selangor (MY); Rahman Wagiran, Selangor (MY); Azlan Abdul Aziz, Selangor (MY); Mohd. Rasid Osmann, Selangor (MY); Abd. Rahim Abu Talib, Selangor (MY); Mohd. Fadlee A. Rasid, Selangor (MY); M. Iqbal Saripan, Selangor (MY)

(72) Inventors: Mohd. Saleh Jaafar, Selangor (MY); Megat Johari Megat Megat Mohd Noor, Selangor (MY); Nor Kamariah Noordin, Selangor (MY); Rahman Wagiran, Selangor (MY); Azlan Abdul Aziz, Selangor (MY); Mohd. Rasid Osmann, Selangor (MY); Abd. Rahim Abu Talib, Selangor (MY); Mohd. Fadlee A. Rasid, Selangor (MY); M. Iqbal Saripan, Selangor (MY)

(73) Assignee: UNIVERSITI PUTRA MALAYSIA, Selangor (MY)

(21) Appl. No.: 13/702,550

(22) PCT Filed: Jun. 20, 2011
(86) PCT No.: PCT/MY2011/000115

§ 371 Date: Apr. 2, 2013

(30) Foreign Application Priority Data
Jul. 2, 2010 (MY) PI 2010003169

(51) Int. Cl. G06Q 50/20; G06Q 10/00

(52) U.S. Cl. CPC G06Q 50/205; G06Q 10/00
USPC 705/326

(57) ABSTRACT

The present invention relates to a system to administer an outcome based education for higher learning academic programs, the system includes: (a) at least one design process (100), wherein the design process (100) encompasses planning structure for achieving required learning outcomes; (b) at least one implementation process (200) to control the planning structure of the design process (100); (c) at least one assessment process (300) to evaluate results of the implementation process (200); wherein results of assessment of the design, implementation and assessment processes are integrated into a database system which is made available for consideration in continual quality improvement (CQI) of an academic program; and wherein implementation of the system enables to monitor complete cycle of design, implementation, assessment, and continual quality improvement processes.

### FIELD OF INVENTION

The present invention relates to a system to administer an outcome based education for higher learning academic programs.

### BACKGROUND OF INVENTION

Outcome based education (OBE) approach is accreditation requirement made by local engineering board council for all learning programs. On top of that, higher learning education ministry of local authority also emphasizes on the implementation of outcome based education approach in all offered programs by Institute of Higher Learning (IHLs) through the introduction of learning outcomes in all academic programs.

Presently, many educational institutions provide various expected learning outcomes for students. These institutions often strive to build a campus that encourages learning both inside and outside the classroom, as well as encourage personal growth. The physical campus, co-curricular activities, extracurricular activities, campus computer networks that foster on-line communities, and other services typically contribute to achieving learning outcomes. Educational institutions attempt to offer many academic programs, as well as create a diverse student experience as part of a holistic approach to education.

Educational institutions can typically determine whether students have fulfilled their particular goals or learning outcomes. However, it is to be found that it is difficult to determine which factors in a student's overall experience significantly contributed to a student achieving the goals or learning outcomes. It is equally difficult for an educational institution to determine which factors were detrimental to or created obstacles for the student in achieving goals or learning outcomes. Knowing which factors are helpful or harmful for a student in achieving goals or learning outcomes is desirable in fostering an environment to attract and retain students.

Accordingly, there exists a need for a system to administer an outcome based education to create improved learning outcomes for students, and determine the factors that have greatest correlation with students attaining goals and achieving learning outcomes, with continuous quality improvement.

### SUMMARY OF INVENTION

The present invention relates to a system to administer an outcome based education for higher learning academic programs, the system includes at least one design process, wherein the design process encompasses planning structure for achieving required learning outcomes; at least one implementation process to control the planning structure of the design process, and at least one assessment process to evaluate results of the implementation process; wherein results of assessment of the design, implementation and assessment processes are integrated into a database system which is made available for consideration in continual quality improvement (CQI) of an academic program. Accordingly, implementation of the system enables to monitor complete cycle of design, implementation, assessment, and continual quality improvement processes.

In accordance with preferred mode, the design process includes entities such as Program Development and Review, List of Stakeholders and Develop/Review Courses. The implementation process includes entity such as Course Implementation (4); and the assessment process includes entities such as Course Assessment, Program Assessment Summative (Internal) and Program Assessment Summative (External).

Accordingly, the Program Development and Review includes attributes such as market survey, internal benchmarking, regulatory body, commissioned study, program outcomes and program objective. The List of Stakeholders includes an internal attribute such as staff, students, university and an external attribute such as industry, government, alumni. The Develop/Review Courses includes attribute such as course outcomes and continent. It will be appreciated that the Program Development and Review, List of Stakeholders and Develop/Review Courses are relatively linked as a group of design process.

In the preferred mode, the Course Implementation of the implementation process includes attribute such as teaching plan, delivery and monitoring.

It will be appreciated that the Course Assessment of assessment process includes attributes such as learning, teaching, and summary. Accordingly, the learning attribute includes elements such as students' assessment by lecturer which used cumulative course marks (CCM). The teaching attribute includes elements such as staff assessment by student, whereby evolution of such includes lecturer, demonstrator, and technician. The summary attribute includes elements such as summary of teaching and learning or course assessment summary (CAS).

Preferably, the Program Assessment Summative (Internal) of the assessment process includes attribute such as exit survey or final year project; and the Program Assessment Summative (External) of the assessment process includes attribute such as alumni survey, employer/industry survey, external assessor/regulatory body. It will be appreciated that he entity of Course Assessment is relatively linked with the Program Assessment Summative (Internal) and Program Assessment Summative (External).

The Course Assessment of the assessment process is also relatively linked with Develop/Review Courses of the design process and Course Implementation (4) of the implementation process through relative courses {Course 1, Course 2, Course 3 . . . , Course n}.

It is to be noted that the system to administer the outcome based education implementation cycle includes all four phases of outcome based education requirements, i.e. the design/review, implementation, assessment/monitoring and continual quality improvement (CQI). Said four phases of the outcome based education requirement can be interpreted based on two levels, i.e. Program Level and Course Level. Accordingly, the Program Level is designed to look at macro levels, while Course Level will provide micro details in the system.

It will be appreciated that the system is adopted by all programs regardless of unique features of the program outcomes or leaning outcomes specific by institute of high learning (IHL). Accordingly, the system to administer an outcome based education enables to create improved learning outcomes for students, and determine the factors that have greatest correlation with students attaining goals and achieving learning outcomes, with continuous quality improvement.

The present invention consists of several novel features and a combination of parts hereinafter fully described and illustrated in the accompanying description and drawings, it being understood that various changes in the details may be made without departing from the scope of the invention or sacrificing any of the advantages of the present invention.

### BRIEF DESCRIPTION OF DRAWING

The present invention will be fully understood from the detailed description given herein below and the accompanying drawings which are given by way of illustration only, and thus are not limitative of the present invention, wherein:

FIG. 1 is an overall flow chat for a system to administer an outcome based education in accordance with preferred mode of present invention.

### DETAILED DESCRIPTION OF PREFERRED MODE

The present invention relates to a system to administer an outcome based education for higher learning academic programs. Hereinafter, this specification will describe the present invention according to the preferred modes of the present invention. However, it is to be understood that limiting the description to the preferred modes of the invention is merely to facilitate discussion of the present invention and it is envisioned that those skilled in the art may devise various modifications and equivalents without departing from the scope of the appended claims.

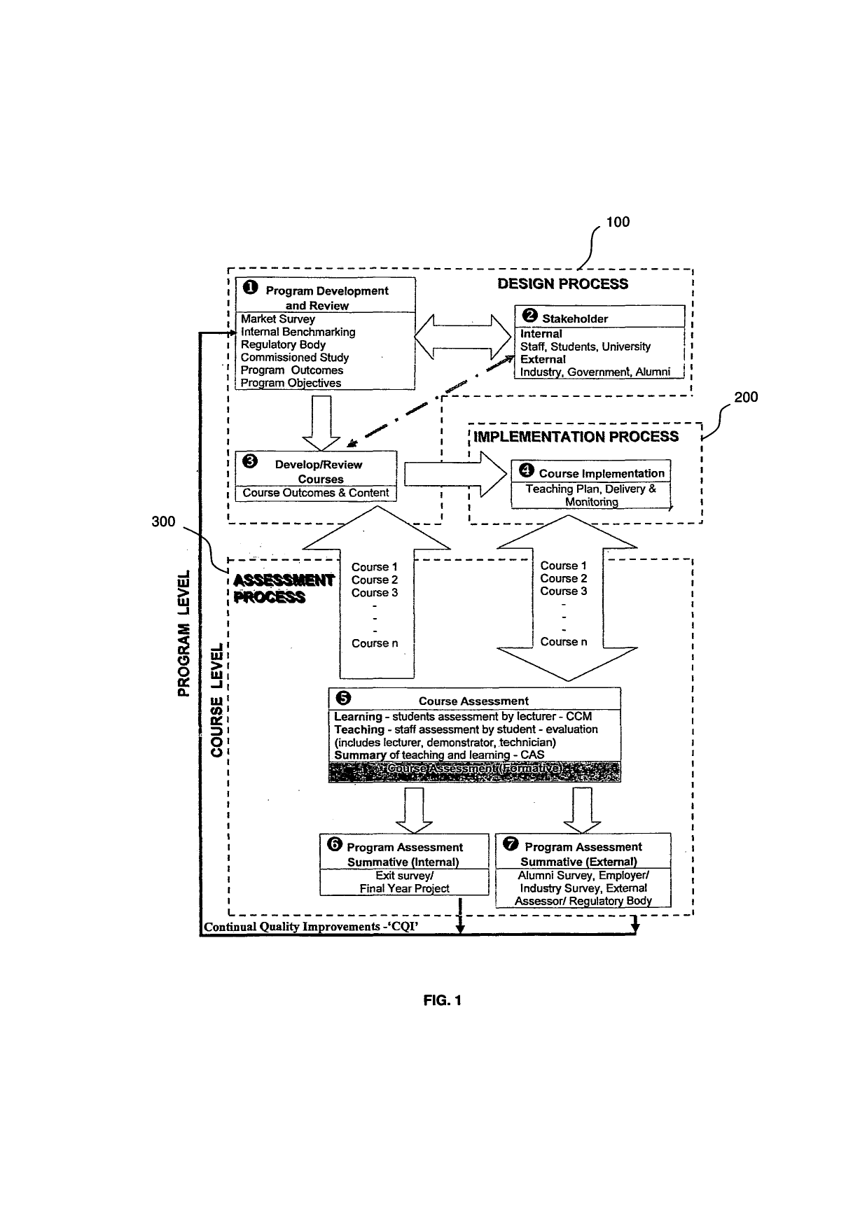

The system to administer the outcome based education for higher learning academic programs according to the preferred modes of the present invention will now be described in accordance to the accompanying drawings FIG. 1.

Accordingly, the system to administer the outcome based education can be categorized into at least three major processes, but not limited to design process (100), implementation process (200) and assessment process (300).

In the preferred mode, the design process (100) encompasses planning structure for achieving required learning outcomes. By way of example and not by way of limitation, the design process (100) may include entities such as Program Development and Review (1), List of Stakeholders (2) and Develop/Review Courses (3).

Accordingly, the Program Development and Review (1) may include attributes such as market survey, internal benchmarking, regulatory body, commissioned study, program outcomes and program objective. The List of Stakeholders (2) may include an internal attribute such as staff, students, university, and an external attribute such as industry, government, alumni. The Develop/Review Courses (3) may include attribute such as course outcomes and continent. It will be appreciated that said entities of Program Development and Review (1), List of Stakeholders (2) and Develop/Review Courses (3) are relatively linked as a group of design process.

It is to be noted that the implementation process (200) of the system enables to control the planning structure of the design process (100). Preferably, the implementation process may include entity such as, but not limited to Course Implementation (4) which having attribute such as teaching plan, delivery and monitoring.

The assessment process (300) of the system enables to evaluate results of the implementation process (200). The assessment process may include entities such as Course Assessment (5), Program Assessment Summative (Internal) (6) and Program Assessment Summative (External) (7). Accordingly, the assessment process takes care of the said entities of Course Assessment (5), Program Assessment Summative (Internal) and Program Assessment Summative (External).

In the preferred mode, the Course Assessment (5) may include attributes such as learning {students assessment by lecturer—which used cumulative course marks (CCM)}, teaching (staff assessment by student—where evolution includes lecturer, demonstrator, technician), and summary {summary of teaching and learning—i.e. course assessment summary (CAS)}. Accordingly, the learning attribute includes elements such as students' assessment by lecturer which used cumulative course marks (CCM). The teaching attribute includes elements such as staff assessment by student, whereby evolution of such includes lecturer, demonstrator, and technician; and the summary attribute includes elements such as summary of teaching and learning or course assessment summary (CAS).

The Program Assessment Summative (Internal) (6) may include attribute such as exit survey or final year project, while the Program Assessment Summative (External) (7) may include attribute such as alumni survey, employer/industry survey, external assessor/regulatory body. It will be appreciated that the entity of Course Assessment (5) is relatively linked with the Program Assessment Summative (Internal) (6) and Program Assessment Summative (External) (7). Said Course Assessment (5) of the assessment process is also relatively linked with Develop/Review Courses (3) of the design process and Course Implementation (4) of the implementation process through relative courses {Course 1, Course 2, Course 3 . . . , Course n}.

It is to be noted that the results of assessment of the mentioned three main processes are integrated into a database system which can be made available for consideration in continual quality improvement (CQI) of an academic program. Accordingly, the implementation of the system enables to monitor complete cycle of all four phases of outcome based education requirements, i.e. design/review, implementation, assessment/monitoring, and continual quality improvement processes (CQI).

It will be appreciated that the four phases of the outcome based education requirements can be interpreted based on two levels, i.e. Program Level and Course Level as indicated in FIG. 1. Accordingly, the Program Level is designed to look at macro levels, while Course Level will provide micro details in the system.

It will also be appreciated that the system may be adopted by all programs regardless of unique features of the program outcomes or leaning outcomes specific by institute of high learning (IHL). Accordingly, the system to administer an outcome based education enables to create improved learning outcomes for students, and determine the factors that have greatest correlation with students attaining goals and achieving learning outcomes, with continuous quality improvement.

The invention being thus described, it will be obvious that the same may be varied in many ways. Such variations are not to be regarded as a departure from the principle and scope of the invention, and all such modifications as would obvious to one skilled in the art intended to be included within the scope of following claims.

1. A system to administer an outcome based education for higher learning academic programs comprising:
(a) at least one design process, wherein the design process encompasses planning structure for achieving required learning outcomes;
(b) at least one implementation process to control the planning structure of the design process and
(c) at least one assessment process to evaluate results of the implementation process;
wherein results of assessment of the design, implementation and assessment processes are integrated into a database system which is made available for consideration in continual quality improvement (CQI) of an academic program; and wherein implementation of the system monitoring of the complete cycle of design, implementation, assessment, and continual quality improvement processes.

2. A system to administer an outcome based education according to claim 1, wherein the at least one design process includes one or more of Program Development and Review, List of Stakeholders and Develop/Review Courses entities.

3. A system to administer an outcome based education according to claim 1, wherein at least one the implementation process includes a Course Implementation entity.

4. A system to administer an outcome based education according to claim 1, wherein the at least one assessment process includes one or more of Course Assessment, Program Assessment Summative (Internal) and Program Assessment Summative (External) entities.

5. A system to administer an outcome based education according to claim 2, wherein the Program Development and Review includes one or more of market survey, internal benchmarking, regulatory body, commissioned study, program outcomes and program objective attributes.

6. A system to administer an outcome based education according to claim 2, wherein the List of Stakeholders includes an internal attribute comprising staff, students, or university, and an external attribute comprising industry, government, or alumni.

7. A system to administer an outcome based education according to claim 2, wherein the Develop/Review Courses includes an attribute comprising course outcomes or continent.

8. A system to administer an outcome based education according to claim 2, wherein the Program Development and Review, List of Stakeholders and Develop/Review Courses are relatively linked as a group of design process.

9. A system to administer an outcome based education according to claim 3, wherein the Course Implementation of the implementation process includes an attribute comprising a teaching plan, delivery or monitoring.

10. A system to administer an outcome based education according to claim 4, wherein the Course Assessment of assessment process includes attributes comprising learning, teaching, or summary.

11. A system to administer an outcome based education according to claim 10, wherein the learning attribute includes elements comprising students' assessment by lecturer which used cumulative course marks (CCM).

12. A system to administer an outcome based education according to claim 10, wherein the teaching attribute includes elements comprising staff assessment by student, whereby evolution of such includes lecturer, demonstrator, and technician.

13. A system to administer an outcome based education according to claim 10, wherein the summary attribute includes elements comprising summary of teaching and learning or course assessment summary (CAS).

14. A system to administer an outcome based education according to claim 4, wherein the Program Assessment Summative (Internal) of the assessment process includes an attribute comprising an exit survey or final year project.

15. A system to administer an outcome based education according to claim 4, wherein the Program Assessment Summative (External of the assessment process includes an attribute comprising alumni survey, employer/industry survey, or external assessor/regulatory body.

16. A system to administer an outcome based education according to claim 4, wherein the entity of Course Assessment is relatively linked with the Program Assessment Summative (internal) and Program Assessment Summative (External).

17. A system to administer an outcome based education according to claim 4, wherein the Course Assessment of the assessment process is also relatively linked with Develop/Review Courses of the design process and Course Implementation of the implementation process through relative courses.

18. A system to administer an outcome based education according to claim 1, wherein the implementation of the system includes four phases of outcome based education requirements, including the design/review, implementation, assessment/monitoring and continual quality improvement (CQI).

19. A system to administer an outcome based education according to claim 18, wherein the four phases of the outcome based education requirements are interpreted based on two levels, including Program Level and Course Level, wherein the Program Level implementation is designed to look at macro levels and the Course Level implementation will provide micro details in the system.

20. A system to administer an outcome based education according to claim 1, wherein the system is adopted by all programs regardless of unique features of the program outcomes or leaning outcomes specific by institute of high learning (IHL).

21. A system to administer an outcome based education according to claim 1, wherein the system enables creation of improved learning outcomes for students, and to determine the factors that have greatest correlation with students attaining goals and achieving learning outcomes with continuous quality improvement.
